(19) United States
(12) Patent Application Publication
(10) Pub. No.: US 2006/0231403 A1
(43) Pub. Date: Oct. 19, 2006

(54) Chambered electrodeionization apparatus with uniform current density, and method of use

(76) Inventor: John M. Riviello, Santa Cruz, CA (US)

Correspondence Address: Shirley L. Church, Esq.;DUCKOR SPRADLING METZGER & WYNNE, A Law Corporation, Suite 2400, 401 West A Street, San Diego, CA, 92101-7909, US

(21) Appl. No.: 11/403,734

(22) Filed: Apr. 12, 2006

Related U.S. Application Data
(60) Provisional application No. 60/671,371, filed on Apr. 14, 2005.

(51) Int. Cl. C02F 1/469; B01D 61/46

(52) U.S. Cl. 204/524; 204/632

(57) ABSTRACT

The present invention pertains to a specialized electrodeionization (EDI) apparatus that includes at least 5 chambers and to a method of using this apparatus. The EDI of the present invention (1) is a continuous EDI (CEDI) apparatus, with constant regeneration of ion exchange materials; (2) has improved removal of all ions as a result of homogeneous anion and cation deletion chambers, while providing a uniform current density within each chamber; (3) has reduced scale accumulation; and (4) has homogeneous anion and cation depletion chambers that are at least 12 mm thick, without the negative impact on performance that is typical in the art of chambers greater than 10 mm thick. Liquids such as water, acids, bases, or salts can be deionized using this apparatus.

### RELATED APPLICATION

Benefit of priority under 35 U.S.C. 119(e) is claimed herein to U.S. Provisional Application No. 60/671,371, filed Apr. 14, 2005. The disclosure of the above referenced application is incorporated by reference in its entirety herein. A related application titled “Method of Ion Chromatography Wherein a Specialized Electrodeionization Apparatus is Used” under U.S. Express Mail No. 611361443US is being filed on the same day as the present application and is hereby incorporated by reference in its entirety.

### BACKGROUND OF THE INVENTION

1. Field of the Invention

The present invention pertains to a specialized electrodeionization (EDI) apparatus that includes at least 5 chambers and to a method of using this apparatus.

2. Brief Description of the Background Art

This section describes background subject matter related to the disclosed embodiments of the present invention. There is no intention, either express or implied, that the background art discussed in this section legally constitutes prior art.

Electrodeionization (EDI) is known in the art as a process which removes ionized species from liquids, such as water, using electrically active media and an electric potential to influence ion transport. A combination of ion-selective membranes and ion-exchange resins are sandwiched between two electrodes (anode (+) and cathode (−)) under a DC voltage potential to remove ions from the liquid. Cationic exchange resins can be used to remove positively charged ions, such as calcium, magnesium and sodium, replacing them with hydronium (H⁺) ions, while anionic exchange resins can be used to remove negatively charged ions, such as chloride, nitrate and silica, replacing them with hydroxide (OH⁻) ions. The H⁺ and OH⁻ ions may subsequently be united to form water molecules. Eventually, the resin beads become saturated with contaminant ions and become less effective at treating the water. Once these resins are significantly contaminated, the high-purity liquid flowing past them may acquire trace amounts of contaminant ions by “displacement effects.” In conventional deionization, the exhausted ion exchange media must be chemically recharged or regenerated periodically with a strong acid (for cation resins) or a strong base (for anion resins). The process of regenerating the ion exchange media with concentrated solutions of strong acids or bases presents considerable cost, time, safety, and waste disposal issues.

Continuous electrodeionization (CEDI), a subset of EDI, uses a combination of ion exchange resins and membranes, and direct current to continuously deionize water, thus eliminating the need to chemically regenerate the ion exchange media. CEDI includes processes such as continuous deionization, filled cell electrodialysis, or electrodiaresis. The ionic transport properties of electrically active media are an important separation parameter. These processes are described, for example, by Kunz in U.S. Pat. No. 4,687,561.

FIG. 1 is a representation of a typical CEDI apparatus, wherein two diluting chambers and one concentrating chamber is are shown, as described, for example, by DiMascio in U.S. Pat. No. 6,284,124; Ganzi in U.S. Pat. No. 6,312,577; and Liang in U.S. Pat. Nos. 6,649,037 and 6,824,662. A typical CEDI comprises alternating electroactive anion exchange membranes (AEM) and cation exchange membranes (CEM). The spaces between the membranes are configured to create liquid flow chambers, with inlets and outlets. A transverse DC electrical field is imposed by an external power source (not shown) using electrodes at the bounds of the membrane chambers. The cathode is shown as a minus sign (−) at the left side and the anode is shown as a plus sign (+) at the right side in FIG. 1. Upon imposition of an electric field, ions in a liquid which is being processed are attracted to their respective counter-electrodes. The liquid in chambers with an electroactive anion membrane on the side of the chamber facing the anode and an electroactive cation membrane on the side of the chamber facing the cathode becomes ionically depleted, or dilute. Conversely, the liquid in chambers with an electroactive cation membrane on the side of the chamber facing the anode and an electroactive anion membrane on the side of the chamber facing the cathode becomes ionically concentrated. The volume within ion-depleting chambers, and often within ion-concentrating chambers, typically contains electrically active media, such as cation exchange resins and/or anion exchange resins. The ion-exchange media enhance the transport of ions within the chambers and may participate as a substrate for electrochemical reactions. In FIG. 1 a sodium chloride (NaCl) solution is being fed through the system. Sodium cations (Na⁺) and chloride anions (Cl⁻) are being removed in the ion-depleting chambers and are being transported to the ion-concentrating chamber.

U.S. Pat. No. 6,284,124 to DiMascio et al., issued Sep. 4, 2001 describes an EDI apparatus and method which employ ion depleting chambers in which alternating layers of cation exchange resins and anion exchange resins are positioned. Each ion depleting chamber includes an anion permeable membrane and a cation permeable membrane, with a central space into which the alternating layers of ion exchange resins are placed. Typically one of the alternating layers is doped to provide a more balanced current distribution through the apparatus. The invention relates to the use of alternating layers of anion exchange resins and cation exchange resins positioned in an ion depleting chamber, while reducing the difference in conductivity between the alternating layers by adding a dopant material to one of the layers.

U.S. Pat. No. 6,312,577 to Ganzi et al., issued Nov. 6, 2001, describes a continuous EDI apparatus which is said to enable the removal of weakly ionized ions, particularly silica, from liquids. The apparatus and method involve using a mixed bed of macroporous anion and cation exchange resins which are highly crosslinked and which have a high water content. Preferably the macroporous ion exchange resin beads are substantially uniform in diameter. The macroporous ion exchange resins are used in a single or multiple compartment formats. Typically an apparatus includes three compartments. A center ion-depleting compartment, with an ion-concentrating compartment on each side. The sides along the length of the ion-depleting compartment and each ion-concentrating compartment are sealed with an anion-permeable membrane on one side and a cation-permeable membrane on the other side, where the exterior anion-permeable membrane is adjacent a cathode, while the exterior cation-permeable membrane is adjacent an anode. The liquid flows parallel to the permeable membranes.

U.S. Pat. No. 6,482,304 to Emery et al, issued Nov. 19, 2002, describes an EDI apparatus which includes a first deionizing flow path and an integral second deionizing flow path. The outflow from the first path is held in a holding tank prior to passage through the second flow path, and the outflow from the second path is available for use. In some instances, the outflow from the second path is partly or fully returned to the holding tank. The recirculation of the already purified water in the holding tank is said to maintain the water in the holding tank at a higher standard than otherwise “standing” purified water. (Abstract) The apparatus includes at least a centrally arranged concentrating chamber into which anions and cations desired to be removed are concentrated and removed. The flow path for the water to be purified preferably passes through an anion exchange material first, followed by passage through a cation exchange material. Preferably, the anion exchange material is an anion exchange resin and the cation exchange material is a cation exchange resin.

U.S. Pat. No. 6,596,145 to Moulin et al., issued Jul. 22, 2003 describes an EDI apparatus formed from an anode spaced apart from a cathode, one or more waste channels formed between the electrodes and a product channel located inward of the waste channel(s). Ion permeable membranes form the boundary between the product channel and the waste channel(s). The product channel is bounded by an anion permeable membrane and a cation permeable membrane. The product channel and the waste channels are filled with a mixed bed of anionic and cationic ion exchange materials (Abstract) which are typically solid beads available from various commercial sources. The anion permeable membrane is spaced apart from the anode and the cation permeable membrane is spaced apart from the cathode with the spacing in each case providing a waste channel between the membrane and the electrode. The anionic materials are selected from the group consisting of either only anionic materials having low affinity for the selected specie(s) or a blend of anionic materials having low affinity for the selected anion specie(s) and Type I ion materials. The anionic materials having relatively low affinity for the anion specie(s) selected are selected from the group consisting of anion materials having weakly basic groups, anion materials having Type II functional groups and mixtures thereof.

U.S. Pat. Nos. 6,649,037 and 6,824,662 to Liang et al., issued Nov. 18, 2003 and Nov. 30, 2004, respectively, describe an EDI apparatus and method for purifying a fluid. Weakly ionizable species such as silica or boron are said to be reduced in concentration by as much as 90% or more, to concentrations less than 100 ppb, using various pH levels to facilitate removal. (Abstract and Col. 4, lines 28-41.) Various combinations of EDI cells and reverse osmosis devices are described, as well as a device which comprises a series of layers of anion and cation exchange materials. A considerable amount of the description and a number of dependent claims relate to the use of a dopant as part of a mixed anion exchange material, where the dopant may be an inert or an electroactive media which is added to balance the conductivity of the layer relative to other layers in the same EDI cell.

U.S. Pat. No. 6,808,608 to Srinivasan et al., issued Oct. 26, 2004 describes an apparatus and method for removing charged contaminants from a water stream. In general, the purifying apparatus is bound by electrodes at either end, with a cathode at the first end and an anode at the second end. Between these two electrodes are a cation chamber, a central purifying flow channel, and an anion chamber. The cation chamber is bound by a cathode and a cation exchange membrane, and contains cation exchange materials, such as cation exchange screens. Likewise, the anion chamber is bound by an anode and an anion exchange membrane, and contains anion exchange materials, such as anion exchange screens. The central purifying flow channel is bound by the cation and the anion exchange membranes described above. This central purifying flow channel may be free of ion exchange material, or it may contain flow-through ion exchange medium with an ion exchange capacity no greater than 25% of the ion exchange media contained within the adjacent chambers.

Many of the EDI apparatuses described above employ layering and doping of the ion exchange material to enhance the EDI purification process. The general art suggests that layered EDI is an improvement over mixed bed EDI. In layered EDI, where anion and cation exchange materials are layered, there is said to be an improvement in ion exchange removal of weakly ionized ions, such as silicate and borate.

One of the major problems indicated in the art for layered EDI is that the electrical resistance through the layers may vary, which results in unbalanced current through the EDI apparatus. Unbalanced current leads to incomplete ion removal and incomplete regeneration in regions of the resin bed where the current is low. Resin regeneration takes place where the majority of current flows and little or no regeneration takes place elsewhere. Therefore, a more highly conductive resin will be regenerated while a less conductive resin will only be minimally regenerated or not regenerated at all, leading to fouling of the less conductive resin.

In order to solve this problem of unbalanced current with layered EDI, the concept of doping layers has been implemented in the art. By doping a layer of ion exchange material in an EDI apparatus, current distribution can be made more even, resulting in enhanced ion removal and regeneration. Doping is accomplished by adding to an ion exchange layer some quantity of a dopant, which serves to increase or decrease the resistance of a layer. A typical dopant in the art may be an inert material, an electrically active non-ion exchange material, or more typically it may be ion exchange material, such as anion or cation exchange resins. The process setting up an EDI apparatus with doped layers is complex and time consuming. Determining the type and quantity of dopant is an empirical process, which may lead to a more complex design. Thus an improved EDI apparatus and method for EDI that achieves the advantages of layered and doped EDI apparatuses (such as improved removal of weakly ionized ions, such as silicate and borate, while maintaining uniform current) without the complexity of layering and doping is needed in the art.

The general art indicates that the presence in liquids of calcium, magnesium, and carbonate can result in a build up of scale (deposition of mineral compounds) in an EDI apparatus. Scale typically causes an increase in electrical resistance and a drop in the product quality. In severe cases, scale can cause a drop in liquid flow through the EDI apparatus. Scale also increases the frequency of cleaning required for an EDI apparatus, if product quality is to be maintained. Most EDI apparatuses cannot tolerate a hardness level above 1 ppm CaCO₃. Thus, before purification of a liquid in an EDI apparatus, pretreatment of the liquid may be required to prevent scale formation. The type of pretreatment required to prevent scale formation is determined by quality required for the product. Often a water softner may be used. The use of a water softener adds to both the hardware and chemical costs of a system and also adds to the amount of waste liquid generated by a system. Alternatively, for many high-purity water needs, a reverse osmosis (RO) pretreatment step is used. This also requires additional hardware and maintenance expense. Thus, there is a need in the art for EDI apparatuses which have reduced scale accumulation.

Conventional EDI apparatuses are commonly described in the art as “thin cell” or “thick cell” EDI apparatuses. The general art indicates that in a “thin cell” EDI apparatus, the width of an ion depletion chamber is 1.5-3.5 mm and in a “thick cell” EDI apparatus, the width of an ion depletion chamber is 8-10 mm. This width is typically the distance between a pair of ion exchange membranes. Within a typical ion depletion chamber is ion exchange media. One of the main advantages of using an EDI apparatus with a thicker chamber is that it can greatly reduce the amount of ion exchange membrane used to construct the device, which significantly reduces the assembly cost (both for materials and labor). Another significant advantage of an EDI apparatus with a thicker chamber is that the thicker resin chambers allow for the purification of larger volumes of fluid within the chamber. The general art indicates that in a conventional EDI, chamber thickness is limited, primarily because thick cell EDI is not considered to be as efficient or to produce as high a water quality as thin cell EDI. This failure in efficiency and quality is attributed to non-uniform current density within the thicker chambers. However, to enable processing of large volumes of liquid in a shorter time period at a reduced cost, there is a need in the art for an EDI apparatus that contains ion depletion chambers with a thickness greater than 10 mm, which do not suffer from an increased electrical resistance or decreased ion removal.

### BRIEF DESCRIPTION OF THE DRAWINGS

FIG. 1 shows a representation of a typical CEDI apparatus from the background art.

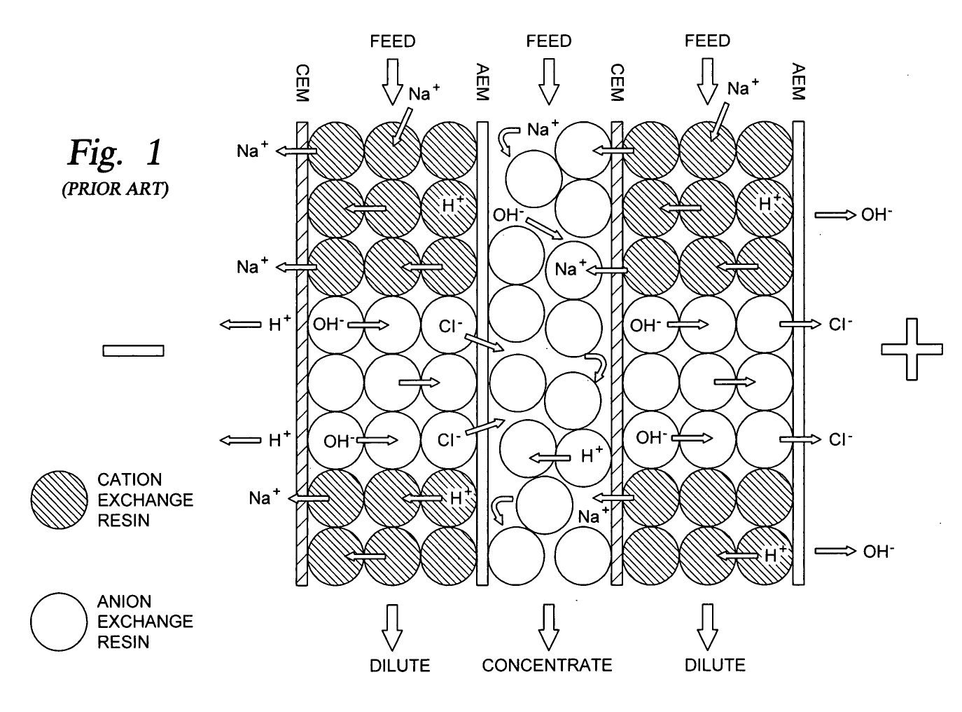

FIG. 2 shows the typical chemical structure of ion exchange materials.

FIG. 3 shows a five chambered CEDI apparatus which is one embodiment of the present invention. This EDI apparatus comprises a cathode chamber, a homogeneous cation depletion chamber, a central heterogeneous anion and cation depletion chamber, a homogeneous anion depletion chamber, and an anode chamber. All of the five chambers are in electrical connection.

FIG. 4 shows ion movement in a central heterogeneous anion and cation depletion chamber, of the kind shown in FIG. 3.

FIG. 5 shows an embodiment of the present invention detailing the ion movement occurring within a CEDI apparatus, of the kind shown in FIG. 3, when Na⁺ and Cl⁻ ions are being removed from a solution of NaCl.

FIG. 6 shows a CEDI apparatus with feed water and product water flow direction as described in Example 1.

FIG. 7 shows a CEDI apparatus with feed water and product water flow direction as described in Example 2.

### ABBREVIATIONS AND DEFINITIONS

The following terms and abbreviations are defined to provide the reader 3 with a better understanding of the invention.

The following abbreviations are used herein:

CEDI=continuous electrodeionization;

EDI=electrodeionization;

The terms “dopant” and “doping agent” refer to a material that is added to another material. In EDI, a dopant, such as an inert material, an electrically active non-ion exchange material, or more typically ion exchange material, such as anion or cation exchange resins is added to a layer of ion exchange resins to adjust the electrical conductivity of the layer.

The terms “hard” and “hardness” when used in reference to water, indicates water that contains percentages of various minerals, such as calcium and magnesium carbonates, bicarbonates, sulfates, or chlorides, due to prolonged contact with rocky substrates and soils. Such hardness in water tends to discolor, scale, and corrode materials.

The term “scale” refers to a deposit of mineral compounds present in water, e.g., calcium carbonate.

The term “water splitting” refers to the hydrolysis of water to hydronium and hydroxide ions, which occurs at the interface of anion exchange materials and cation exchange materials in the presence of an electric potential. This is not a true electrochemical process, and differs from the electrolysis of water at an electrode, where hydrogen and oxygen gases are produced.

### DETAILED DESCRIPTION OF EXEMPLARY EMBODIMENTS OF THE INVENTION

As a preface to the detailed description presented below, it should be noted that, as used in this specification and the appended claims, the singular forms “a”, an and “the” include plural referents, unless the context clearly dictates otherwise.

Use of the term “about” herein indicates that the named variable may vary to ±10%.

The present invention is directed to an electrodeionization (EDI) apparatus, which can be used for the purification of liquids and that (1) is a continuous EDI (CEDI) apparatus, with constant regeneration of ion exchange materials; (2) that has the advantages of an EDI apparatus with layered and doped ion exchange material (improved regeneration, ion removal capacity, and balanced current flow), without the complexity of preparing such an apparatus; (3) that has reduced scale accumulation; and (4) that typically has anion and cation depletion chambers with a thickness of at least 12 mm, while not resulting in increased electrical resistance and decreased ion removal.

The inventive CEDI apparatus has at least five discreet membrane bound chambers in electrical connection, comprising: (1) a cathode chamber; (2) a homogeneous cation depletion chamber; (3) a central heterogeneous anion and cation depletion chamber; (4) a homogeneous anion depletion chamber; and (5) an anode chamber. An electrical current runs through the CEDI apparatus transverse to the membranes.

When additional (more than five) membrane bound chambers are present, they are typically present in pairs of additional homogeneous anion and cation depletion chambers, which are added in line next to existing like chambers, which are present between an electrode and the central heterogeneous anion and cation depletion chamber.

The CEDI apparatus of the present invention is capable of carrying liquid flow through all chambers. This liquid flow can be diverted from one chamber to another. Typically, liquid flow from the electrode chambers will not be directed to the ion depletion chambers. In some applications the liquid flow is from the homogeneous cation depletion chamber to the homogeneous anion depletion chamber and then to the central heterogeneous anion and cation depletion chamber. In other applications the liquid flow is from the homogeneous anion depletion chamber to the homogeneous cation depletion chamber and then to the central heterogeneous anion and cation depletion chamber. Typically, liquid will be directed to all chambers in order to keep the ion exchange material in the chambers hydrated.

A cathode chamber is bound on one side by a cation exchange membrane from a homogeneous cation depletion chamber, and contains a cathode that is in direct electrical contact with the cation exchange membrane.

A homogeneous cation depletion chamber is bounded by two cation exchange membranes and contains a volume of homogeneous cation exchange material. The cation exchange material may include cation exchange resins, cation exchange particles, cation exchange fibers, cation exchange screens, cation exchange monoliths, and combinations thereof. Commonly, the cation exchange material is a volume of homogeneous cation exchange resin.

In a CEDI apparatus of the present invention, each homogeneous cation depletion chamber exhibits a thickness (w₁) which may range from about 12 mm to about 100 mm. Typically, a homogeneous cation depletion chamber has a thickness (w₁) ranging from about 15 mm to about 40 mm.

A central heterogeneous anion and cation depletion chamber is bounded by a cation exchange membrane from a homogeneous cation depletion chamber and an anion exchange membrane from a homogeneous anion depletion chamber, and the chamber contains a heterogeneous mix of anion and cation ion exchange material. The ion exchange material is selected from the group consisting of ion exchange resins, ion exchange particles, ion exchange fibers, ion exchange screens, ion exchange monoliths, and combinations thereof. Typically, the ion exchange material is a heterogeneous mixed bed of resins comprising a mixture of cation exchange resins and anion exchange resins.

In a CEDI apparatus of the present invention, a central heterogeneous anion and cation depletion chamber exhibits a thickness (w₃) which may range from about 1 mm to about 100 mm. Typically, the central heterogeneous anion and cation depletion chamber has a thickness (w₃) ranging from about 4.5 mm to about 12 mm.

Each homogeneous anion depletion chamber is bounded by two anion exchange membranes and contains a volume of homogeneous anion exchange material. The anion exchange material is selected from the group consisting of anion exchange resins, anion exchange particles, anion exchange fibers, anion exchange screens, anion exchange monoliths, and combinations thereof. Commonly, the anion exchange material is a volume of homogeneous anion exchange resin.

In a CEDI apparatus of the present invention, each homogeneous anion depletion chamber thickness (w₂) which ranges from about 12 mm to about 100 mm. Typically, a homogeneous anion depletion chamber has a thickness (w₂) ranging from about 15 mm to about 40 mm.

Commonly, a CEDI apparatus of the present invention has a ratio of the width of the summation of homogeneous cation depletion chamber(s) to the central heterogeneous anion and cation depletion chamber to the summation of homogeneous anion depletion chamber(s) (w₁:w₃:w₂) that ranges from about 1:1:1 to 20:1:20. In general, the width of the summation of homogeneous cation depletion chamber(s) (w₁) is equal to the width of the summation of homogeneous anion depletion chamber(s) (w₂), but in some specialized instances, it may be desirable to have one depletion chamber larger than the other.

An anode chamber is bound on one side by an anion exchange membrane from a homogeneous anion depletion chamber, and contains an anode that is in direct electrical contact with the anion exchange membrane.

Ion exchange membranes work by passive transfer and not reactive chemistry. They contain functional sites, which allow for the exchange of ions. The transfer of ions through the ion exchange membrane is based upon the charge of the ion. They will readily admit small ions but resist the passage of bulk water, for example and not by way of limitation. Ion exchange membranes may be anion exchange membranes or cation exchange membranes, wherein they are selective to anions or cations respectively. An anion exchange membrane will transport anions through the membrane, but the membrane prevents the bulk flow of liquid from one side of the membrane to the other. A cation exchange membrane will transport cations through the membrane, but the membrane prevents the bulk flow of liquid from one side of the membrane to the other. A property common to both types of membranes is that they must be conductive so that ions may migrate through the ion exchange membrane towards their respective electrodes.

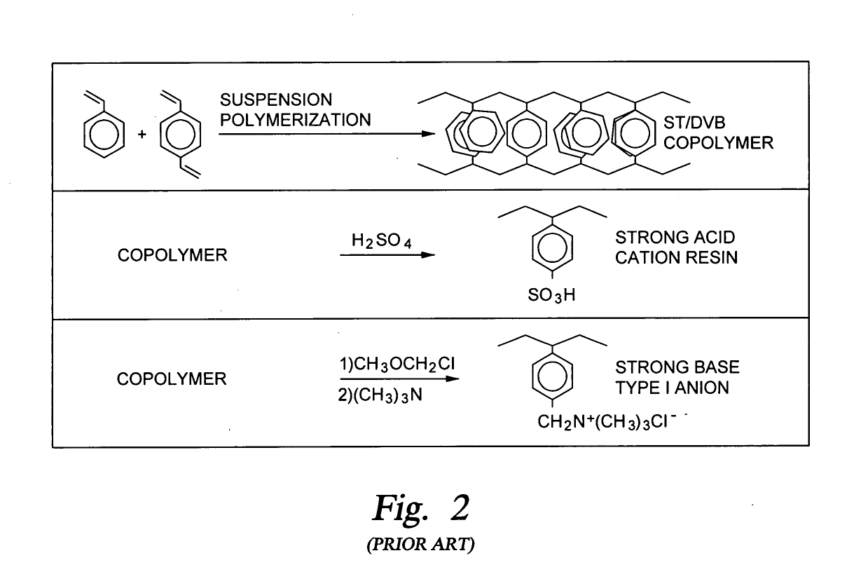

An example of an advantageous anion exchange membrane is a microporous copolymer of styrene and divinylbenzene that has been chloromethylated and then the pendant —CH₂Cl groups that were introduced to the aromatic rings are then quaternized with a tertiary amine R₁R₂R₃N (see FIG. 2). This results in a membrane which is a strong base anion exchanger. In some cases, the anion exchange membrane may also contain a binder polymer. An example of an anion exchange membrane that could be used in the present invention is the AMI-7000S membrane (Membranes International, Glen Rock, N.J.).

An example of an advantageous cation exchange membrane is a microporous copolymer of styrene and divinylbenzene that has undergone sulfonation, resulting in the monosubstitution of —SO₃H groups on the aromatic rings of the copolymer (see FIG. 2). This results in a membrane which is a strong acid cation exchanger. In some cases, the cation exchange membrane may also contain a binder polymer. One example of a cation exchange membrane that could be used in the present invention is the CMI-7000S membrane (Membranes International, Glen Rock, N.J.).

Ion exchange resins contain functional sites, which allow for the exchange of ions. The interaction between ions and the ion exchange resins is based upon the charge of the ion. They will readily admit small ions and molecules but resist the intrusion of species of even a few hundred molecular weight. Ion exchange resins may be anion exchange resins or cation exchange resins, wherein they are selective to anions or cations respectively.

An example of an advantageous anion exchange resin is a microporous copolymer of styrene and divinylbenzene that has been chloromethylated and then the pendant —CH2Cl groups that were introduced to the aromatic rings are then quaternized with a tertiary amine R₁R₂R₃N (see FIG. 2). This results in a resin which is a strong base anion exchanger. There are several commercially available resins of this type. One example of an anion exchange resin that could be used in the present invention is the Dowex 1x4 resin (Dow Chemical Company, Midland, Mich.), which contains 4% divinylbenzene and is in the form Cl⁻.

An example of an advantageous cation exchange resin is a microporous copolymer of styrene and divinylbenzene that has undergone sulfonation, resulting in the monosubstitution of —SO₃H groups on the aromatic rings of the copolymer (see FIG. 2). This results in a resin which is a strong acid cation exchanger. There are several commercially available membranes of this type. One example of a cation exchange membrane that could be used in the present invention is the Dowex 50Wx4 resin (Dow Chemical Company, Midland, Mich.), which contains 4% divinylbenzene and is in the ionic form H⁺.

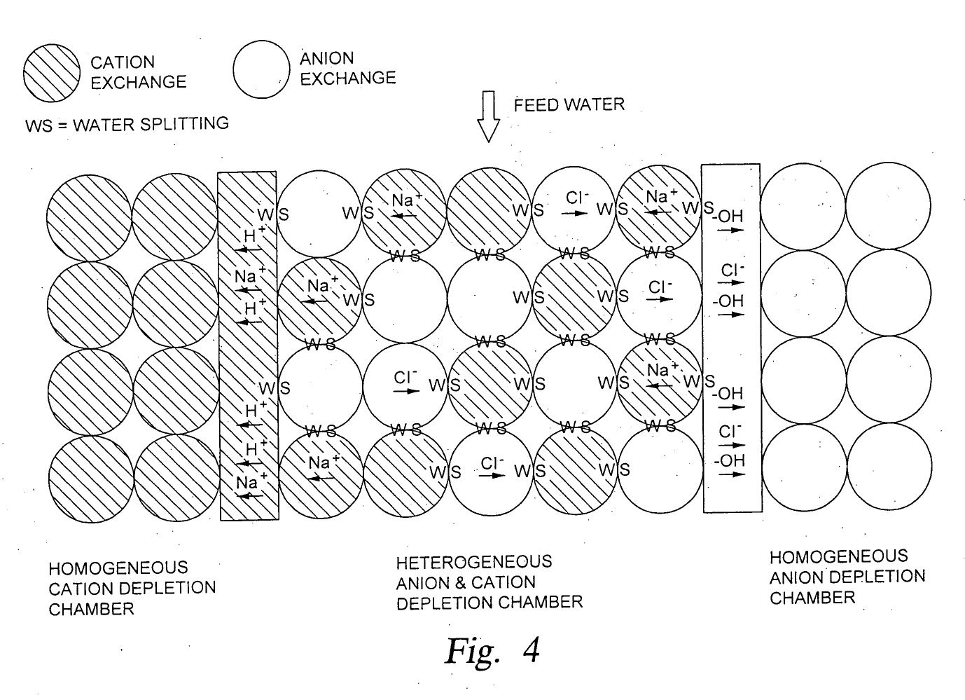

The central heterogeneous anion and cation depletion chamber of the CEDI apparatus of the present invention is packed with a mixture of anion and cation exchange resin. The movement of ions in this central heterogeneous anion and cation depletion chamber is depicted in FIG. 4.

The central heterogeneous anion and cation depletion chamber serves two critical functions. First, when an electric field is applied, water splitting occurs wherever anion and cation exchange material are in direct contact with one another. Water splitting occurs where a cation and anion exchange resin contact one another, or where a cation exchange resin contacts an anion exchange membrane or where an anion exchange resin contacts a cation exchange membrane. Water splitting results in the production of hydroxide (OH⁻) and hydronium (H⁺), which serve to maintain the anion exchange resin in the hydroxide form and the cation exchange resin in the hydronium form, respectively. As well as keeping the resins of the central heterogeneous anion and cation depletion chamber fully regenerated, the hydroxide and hydronium formed at the resin membrane interfaces of the central heterogeneous anion and cation depletion chamber serve to provide hydroxide for the at least one homogeneous anion depletion chamber(s) and hydronium for the at least one homogeneous cation depletion chamber(s).

The second purpose of the central heterogeneous anion and cation depletion chamber is to remove from the feed water, the few remaining (if any) anions not removed by the homogeneous anion depletion chamber and the few remaining (if any) cations not removed by the homogeneous cation depletion chamber. Ion transport in a mixed bed resin relies on both water splitting as well as electrophoretic migration of the ion through the resin. Water splitting can displace contaminant ions from the ion exchange resin. These contaminant ions are then driven through the mixed resin bed of the central heterogeneous anion and cation depletion chamber towards their respective electrode chambers. Thus, contaminant cations are driven through the central heterogeneous anion and cation depletion chamber, through a cation exchange membrane, through the homogeneous cation depletion chamber(s), and through a cation exchange membrane, to the cathode chamber. Likewise, contaminant anions are driven through the central heterogeneous anion and cation depletion chamber, through an anion exchange membrane, through the homogeneous anion depletion chamber(s), and through an anion exchange membrane, to the anode chamber.

Water splitting generates hydronium (H⁺) and hydroxide (OH⁻) ions which can be used to regenerate ion exchange materials. Under the force of an applied electric field, water splitting can occur at the junction of anion and cation exchange materials. These junctions occur in the central heterogeneous anion and cation depletion chamber, since this chamber contains both anion and cation exchange materials and membranes. H+ from the central heterogeneous anion and cation depletion chamber travels through the cation exchange membrane to the homogeneous cation depletion chamber, thus regenerating the cation exchange resins found within. Likewise, OH− from the central heterogeneous anion and cation depletion chamber travels through the anion exchange membrane to the homogeneous anion depletion chamber, thus regenerating the anion exchange resins found within.

For a contaminant ion to be removed from the central heterogeneous anion and cation depletion chamber, the contaminant ion must either come in contact with the respective membrane or be retained by an ion exchange resin particle in contact with a like ion exchange membrane (cation resin-cation membrane or anion resin-anion membrane). An ion that is in a resin particle and electrophoretically migrating through the resin can only move to the next like particle if the two particles are in contact with one another, or if the contaminant ion leaves the resin particle as a result of water splitting. Since the central heterogeneous anion and cation depletion chamber contains a mixture of anion and cation exchange resin, it is statistically unlikely there will be a continuous path of like resin particles any significant distance, thus, electrophoretic migration in the central chamber must be accompanied by displacement and retention (caused by water splitting) for efficient ion removal. This in contrast to the mechanism of ion removal in the homogeneous anion depletion chamber and homogeneous cation depletion chamber where no water splitting occurs (since these chambers contain only one type of ion exchange material). In the homogeneous anion depletion chamber and homogeneous cation depletion chamber contaminant ions are removed by electrophoretic migration through the resin bed to and through the ion exchange membrane and ultimately to the electrode.

For example, chloride retained by the anion exchange resin of the central heterogeneous anion and cation depletion chamber can be displaced by water splitting. The OH⁻ formed from water splitting can displace the contaminant anion (for example Cl⁻) from the anion exchange resin and the chloride goes into solution where it is “paired” with H⁺ from the water splitting reaction. The contaminant Cl⁻ (as hydrochloric acid, HCl) can now move through the mixed resin bed where it will be retained again by anion exchange, where the displacement-retention mechanisms continue to occur. Eventually, the contaminant Cl⁻ will come in contact with an anion exchange resin particle that is in contact with the anion exchange membrane, and the contaminant Cl⁻ ion will be passed through the anion membrane into the anion depletion chamber.

The analogous situation occurs for a cation contaminant. For example, sodium retained by the cation exchange resin of the central heterogeneous anion and cation depletion chamber can be displaced by water splitting. The H⁺ formed from water splitting can displace the contaminant cation (for example Na⁺) from the cation exchange resin and the cation goes into solution where it is “paired” with OH⁻ from the water splitting reaction. The contaminant Na⁺ (as sodium hydroxide, NaOH) can now move through the mixed resin bed where it will be retained again by cation exchange, where the displacement-retention mechanisms continue to occur. Eventually, the contaminant Na⁺ will come in contact with a cation exchange resin particle that is in contact with the cation exchange membrane, and thus the contaminant Na⁺ ion will be passed through the cation membrane into the cation depletion chamber.

In a layered EDI device of the kind described in the background art, water splitting occurs at the junction of anion and cation resin layers as well as resin-membrane interfaces. This makes the device less current efficient, and result in regions in the layers or cells where ion removal and regeneration is inefficient. In the background art, doping of a layer is taught as a means to balance the current flow. Determining the type and quantity of dopant is an empirical process, which may lead to a more complex design.

The generation of a uniform current through the chambers of the CEDI apparatus of the present invention, without the use of layering or doping of ion exchange material provides an unexpected result. The uniform current is attributed to the geometry of the CEDI apparatus and the homogeneity of the homogeneous anion depletion chamber(s) and the homogeneous cation depletion chamber(s). The regeneration of the homogeneous anion and cation depletion chambers results from water splitting in the central heterogeneous anion and cation depletion chamber, which is disposed between the homogeneous anion and cation depletion chambers. In the current invention, the water splitting only occurs in the heterogeneous mixed bed of cation and anion exchange resins of the central heterogeneous anion and cation depletion chamber. This water splitting results in the regeneration of the ion exchange material within the five chambers of the CEDI apparatus. The homogeneous anion depletion chamber and homogeneous cation depletion chamber are homogeneous with respect to the ion exchange material in each chamber and these chambers are disposed symmetrically about the central heterogeneous anion and cation depletion chamber. Since these three chambers are disposed symmetrically between the electrodes, the result is a uniform and balanced current which result in efficient ion removal and regeneration. In the present invention no doping or layering is required, in order to achieve balanced current throughout the device. This is an unexpected result.

Since the central heterogeneous anion and cation depletion chamber of the CEDI apparatus of the present invention is located between the homogeneous anion depletion chamber (containing only anion exchange resins) and the homogeneous cation depletion chamber (containing only cation exchange resin), and since the source of regenerant ion is disposed symmetrically about the anion and cation depletion chambers, the current flow will be balanced throughout all five chambers of this CEDI apparatus. This results in improved ion removal, improved regeneration and better current efficiency since most of the regenerant ions produced from water splitting in the central chamber can migrate to their respective ion depletion chambers.

The present invention offers an improved apparatus and method for CEDI that achieves the advantages of layered and doped EDI devices without the complexity of layering and doping. The geometry of the EDI apparatus of the present invention is self-balancing with respect to the current, and thus doping of layers is not required. This results from the fact that all the chambers and all ion exchange materials in the CEDI apparatus of the present invention are in a uniform electric field, thus current flow has to be identical throughout the homogeneous anion depletion chamber, the central heterogeneous anion and cation depletion chamber, and the homogeneous cation depletion chamber. Water splitting occurs only in the mixed bed of the central heterogeneous anion and cation depletion chamber. Both the homogeneous anion depletion chamber and the homogeneous cation depletion chamber will be uniformly regenerated, because all of the regenerant ions are produced in the central heterogeneous anion and cation depletion chamber.

Therefore the combination of a homogeneous anion depletion chamber, with a central heterogeneous anion and cation depletion chamber, which is of minimal relative thickness (w₃), with a homogeneous cation depletion chamber, which is typically of the same thickness as the homogeneous anion depletion chamber (w₁ and w₂), assists in the maintenance of a generally uniform electric field across the EDI apparatus. No doping of layers is required, which results in a CEDI apparatus which is simpler to manufacture, more reproducible, and more reliable.

The CEDI apparatus of the present invention is very different from the background art, where water splitting occurs throughout the device resulting in an unsymmetrical current flow and inconsistent regeneration and deionization. All of the wide chambers of the CEDI apparatus of the present invention have a uniform ion movement and uniform current. Further, there is continuous and uniform dynamic regeneration of the ion exchange material, generally resulting in balanced current throughout the CEDI apparatus.

The present invention is a CEDI apparatus that contains homogeneous cation depletion chambers and homogeneous anion depletion chambers with a thickness (w₁ and w₂) of at least 12 mm. The distance between the membrane pair in the homogeneous anion depletion chamber or the homogeneous cation depletion chamber (w₁ and w₂) ranges from about 12 mm to about 100 mm, depending on the volume of fluid being purified. The thickness (w₁ and w₂) of these chambers in the present invention CEDI apparatus can be greater than the ion depletion cells of EDI apparatuses previously used, because the homogenous resin beds are uniformly conductive.

The CEDI apparatus of the present invention also differs from those described in the background art in that it has a high ratio of ion exchange resin to ion exchange membrane. The background art EDI devices rely on large membrane area, a short path between membranes in a cell (typically less than 8 mm) and thus a relatively small volume of ion exchange resin between the membranes. The background art devices rely primarily on the contaminant ions being removed by the membrane as the liquid passes through the cell. The present invention CEDI apparatus relies more on retention of contaminant ions by the ion exchange resin and subsequent ion transfer of the contaminant ion through the ion exchange resins to the ion exchange membrane. The CEDI apparatus of the present invention relies on the contaminant ion being taken up by the homogeneous ion exchange resin and then driven by the force of the electric field through the ion exchange resin to the ion exchange membrane where the contaminant is ultimately removed in the adjacent electrode chamber.

For example, in one embodiment of the present invention, the fluid to be purified may first be passed through a homogeneous anion depletion chamber, where contaminant anions are removed from the fluid and transferred to the anode chamber where they are removed as waste. The fluid then leaves the homogeneous anion depletion chamber essentially free of contaminant anions and is then directed to a homogeneous cation depletion chamber where contaminant cations are removed and transferred to the cation depletion chamber to be removed as waste. The fluid then leaves the homogeneous cation depletion chamber essentially free of contaminant anions and cations and is then directed to the central heterogeneous anion and cation depletion chamber. This chamber serves as a final check, eliminating any remaining contaminant anions and cations present in the purified fluid.

The CEDI apparatus of the present invention has a ratio of chamber size from 1:1:1 up to 20:1:20 for the homogeneous cation depletion chamber: central heterogeneous anion and cation depletion chamber: homogeneous anion depletion chamber (w₁:w₃:w₂). The fluid to be purified first flows through the homogeneous cation depletion chamber and anion depletion chamber where cations and anions are removed. These chambers are quite thick (w₁ and w₂) and thus contain a large volume of cation and anion depletion resins respectively. This allows for very efficient removal of ions from the fluid. After the fluid has passed through the homogeneous cation depletion chamber and homogeneous anion depletion chamber, it is then directed to the central heterogeneous anion and cation depletion chamber. This chamber can be smaller in size (w₃), since virtually all of the contaminant ions have already been removed.

Removal of contaminant ions by the central heterogeneous anion and cation depletion chamber is only a secondary purpose of this chamber. The main purpose of the central heterogeneous anion and cation depletion chamber is water splitting, to maintain continuous and uniform regeneration of the ion exchange material, resulting in balanced current throughout the CEDI apparatus of the present invention. Only a small volume of a mixed bed of anion and cation exchange resin is required for this function.

Electrolysis of water occurs in each of the electrode chambers of the CEDI apparatus of the present invention. Hydronium (H⁺) ions from the electrolysis in the anode chamber combine with anions which migrate from the ion depleting chambers into the anode chamber to form an acidic solution. This acidic solution can be diverted from the anode chamber to the cathode chamber to prevent scaling.

The liquid flow within the chambers of the CEDI apparatus of the present invention is parallel to the membranes and perpendicular to the electric current. In one embodiment, the liquid flow within the homogeneous anion depletion chamber(s) and the homogeneous cation depletion chamber(s) can be perpendicular to the membranes and parallel to the electric current, while the liquid flow within the central heterogeneous anion and cation depletion chamber will remain parallel to the membranes and perpendicular to the electric current.

It would be possible to reverse the polarity in the CEDI apparatus of the present invention, wherein the first chamber is an anode chamber, the second chamber is a homogeneous cation depletion chamber, the third chamber is a central heterogeneous ion concentration chamber, the fourth chamber is a homogeneous anion depletion chamber, and the fifth chamber is a cathode chamber.

An Apparatus for Practicing the Invention

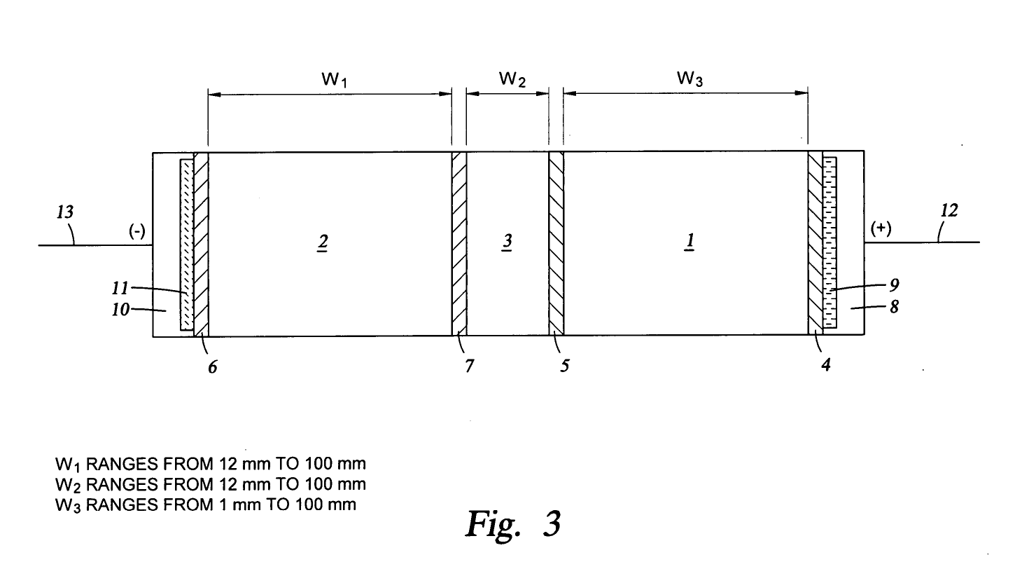

The embodiment example apparatus used for experimentation during development of the apparatus and method is shown in FIG. 3.

FIG. 3 is a detailed drawing of a typical embodiment of the CEDI apparatus of the present invention. The body of the device (not shown in this figure) is constructed of some inert, non conducting material. Such material for the device body can be common thermoplastics such as polyethylene (PE), polypropylene (PP) or polyether-ether ketone (PEEK). The body of the device (not shown) services to contain the ion exchange components, electrodes and define the liquid flow.

The following is a detailed description of a typical device as shown in FIG. 3.

The anode chamber contains an anode which is typically constructed of platinum wire, mesh or film and is connected electrically to a DC power supply (not shown) by a lead wire. Separating the anode chamber from the homogeneous anion depletion chamber is anion exchange membrane. The anion exchange membrane is in electrical contact with the anode and the anion exchange membrane permits the passage of anions between the homogeneous anion depletion chamber and the anode chamber.

The homogeneous anion depletion chamber is filled with anion exchange material which consists of resin, particle, fibers, screen, monoliths, or a combination thereof. Typically, the anion exchange material is anion exchange resin. Defining the end of the homogeneous anion depletion chamber opposite the first anion exchange membrane is another anion exchange membrane. This second anion membrane separates the homogeneous anion depletion chamber from the central heterogeneous anion and cation depletion chamber.

The cathode chamber contains a cathode which is typically constructed of platinum or stainless steel wire, mesh or film and is connected electrically to a DC power supply by lead wire. Separating the cathode chamber from the homogeneous cation depletion chamber is a cation exchange membrane. The cation exchange membrane is in electrical contact with the cathode. The cation exchange membrane permits the passage of cations between the homogeneous cation depletion chamber and the cathode chamber.

The homogeneous cation depletion chamber is filled with cation exchange material consisting of resin, particle, fibers, screen, monoliths, or a combination thereof. Typically, the cation exchange material is cation exchange resin. Defining the end of the homogeneous cation depletion chamber opposite the first cation exchange membrane is another cation exchange membrane. This second cation exchange membrane separates the homogeneous cation depletion chamber from central heterogeneous anion and cation depletion chamber.

The central heterogeneous anion and cation depletion chamber contains a mixture of anion and cation exchange material, which is typically a mixed bed of anion and cation exchange resins.

The homogeneous anion depletion chamber, the central heterogeneous anion and cation depletion chamber, and the homogeneous cation depletion chamber are all in electrical contact and disposed between the anode and the cathode. Electrical contact is maintained by having the electrodes, membrane and ion exchange material in contact. It is important that the anion exchange material be in intimate contact with the anion exchange membranes and that anion exchange membrane be in electrical contact with anode by intimate contact. Cation exchange material must be in intimate contact with the cation exchange membranes and the cation exchange membrane must be in electrical contact with cathode by intimate contact. Similarly, the mixed anion and cation exchange material in central heterogeneous anion and cation depletion chamber must be in intimate contact with anion exchange membrane and cation exchange membrane.

The ratio of chamber size is from 1:1:1 up to 20:1:20 for the homogeneous cation depletion chamber: central heterogeneous anion and cation depletion chamber: homogeneous anion depletion chamber (w₁:w₃:w₂). The homogeneous cation depletion chamber thickness (w₁) that ranges from about 12 mm to about 100 mm, and typically has a thickness (w₁) ranging from about 15 mm to about 40 mm. The central heterogeneous anion and cation depletion chamber exhibits a thickness (w₃) which may range from about 1 mm to about 100 mm, and typically has a thickness (w₃) ranging from about 4.5 mm to about 12 mm. The homogeneous anion depletion chamber thickness (w₂) that ranges from about 12 mm to about 100 mm, and typically has a thickness (w₂) ranging from about 15 mm to about 40 mm.

Anode feed stream enters the anode chamber and passes over anode and exits anode chamber as anode concentrate. The anode concentrate will contain contaminant anions (in the acid form) which are being removed from the water stream being purified. Similarly, cathode feed stream enters the cathode chamber passing over the cathode and exits the cathode chamber as cathode concentrate. The cathode concentrate will contain contaminant cations (in the base form) which are being removed from the sample water feed stream being purified. Both the anode feed and cathode feed stream can be from the same source and typically is the same source as the sample feed stream. Liquid stream flows into and out of the homogeneous anion depletion chamber forming a liquid stream which then flows to the homogeneous cation depletion chamber. The homogeneous cation depletion chamber is typically filled with cation exchange material such as resin, particle, fiber, screen, monolith, or a combination thereof.

Defining the cathode chamber is a cation exchange membrane. The cation exchange membrane adjacent to the cathode chamber, allows for the transport of cations from the homogeneous cation depletion chamber into the cathode chamber. The liquid stream exiting homogeneous cation depletion chamber is directed to the central heterogeneous anion and cation depletion chamber. The central heterogeneous anion and cation depletion chamber contains a mixture of cation and anion exchange materials. Any anions or cations not removed in the homogeneous anion and cation depletion chambers, will be removed in the central heterogeneous anion and cation depletion chamber. The ion depleted water exits the central heterogeneous anion and cation depletion chamber.

When voltage is applied to the anode and the cathode, the electrolysis of water occurs. Water in the anode chamber is electrochemically oxidized producing hydronium ions, H⁺, and oxygen gas, O₂, at the anode. Simultaneously, at the cathode, water in the cathode chamber is electrochemically reduced producing hydroxide, OH⁻, and hydrogen gas, H₂ at the cathode. These reactions are shown in equations 1 and 2, respectively.
Anode reaction 2H₂O→O₂+4H⁺+4e⁻ Equation 1
Cathode reaction 4H₂O+4e⁻→2H₂+4OH⁻ Equation 2

The anion exchange material in the homogeneous anion depletion chamber is primarily in the hydroxide form while the cation exchange material in the homogeneous cation depletion chamber is primarily in the hydronium form. Anion exchange material primarily in the hydroxide form is referred to as the fully regenerated anion form while cation exchange material in the hydronium form is referred to as the fully regenerated cation form.

Contaminant anions such as chloride, sulfate, phosphate, nitrate, borate, silicate and carbonate from the sample fluid stream will be retained on the anion exchange material in the homogeneous anion depletion chamber. Under the influence of the electric field, the contaminant anions will be electrophoretically driven through the anion exchange material into, and through the anion exchange membrane and combine with hydronium in the anode chamber to form the corresponding acid such as hydrochloric, sulfuric, phosphoric and boric. Anode concentrate from the anode chamber is diverted to waste. In some instances it is preferable to divert the anode concentrate to the cathode chamber via the cathode feed stream. Acid in the anode concentrate can reduce scaling in the cathode chamber.

Anion depleted water flows to the homogeneous cation depletion chamber where contaminant cations such as sodium, potassium, calcium, magnesium and ammonium are retained on the cation exchange material. Under the force of the electric field, the contaminant cations will be electrophoretically driven through the cation exchange material in the homogeneous cation depletion chamber, through the cation exchange membrane and combine with hydroxide in the cathode chamber to form the corresponding bases such as sodium hydroxide, potassium hydroxide and calcium hydroxide. Cathode concentrate from the cathode chamber is diverted to waste.

The ion depleted sample stream then enters the central heterogeneous anion and cation depletion chamber. The central heterogeneous anion and cation depletion chamber contains mixed ion exchange material. Defining the central heterogeneous anion and cation depletion chamber are an anion exchange membrane adjacent to and in electrical contact with the homogeneous anion depletion chamber and a cation exchange membrane adjacent to and in electrical contact with the homogeneous cation depletion chamber. Anions or cations not removed in the homogeneous anion and cation depletion chambers will be retained on the mixed bed ion exchange material in the central heterogeneous anion and cation depletion chamber. The residual contaminant anions in the central heterogeneous anion and cation depletion chamber will be driven electrophoretically through the anion exchange membrane and into the homogeneous anion depletion chamber and eventually to anode chamber. Similarly, residual contaminant cations in the central heterogeneous anion and cation depletion chamber will be driven electrophoretically through the cation exchange membrane and into the homogeneous cation depletion chamber and eventually to cathode chamber.

Regeneration of the ion exchange materials in the homogeneous anion and cation ion depletion chambers and the central heterogeneous anion and cation depletion chamber is accomplished by the splitting of water (hydrolysis) in the central heterogeneous anion and cation depletion chamber which results from the applied electric field. Water splitting (hydrolysis) occurs at the junction of anion and cation exchange materials. Water splitting may occur at a resin-resin junction, resin-membrane junction or membrane-membrane junction where the junction results from two types of ion exchange materials, anion and cation. The resulting hydronium and hydroxide produced from the water splitting are electrophoretically driven towards the anode and cathode respectively.

Hydroxide ion exchanges through the anion exchange membrane and continues to migrate through the anion exchange material in the homogeneous anion depletion chamber before exchanging through the second anion membrane and finally combining with hydronium produced at anode.

Hydronium ion exchanges through the cation exchange membrane and continues to migrate through the cation exchange material in the homogeneous cation depletion chamber before exchanging through the second cation membrane and finally combining with hydroxide produced at cathode.

By applying a potential to the anode and the cathode, all ion exchanged material disposed between the anode and cathode will be continually regenerated.

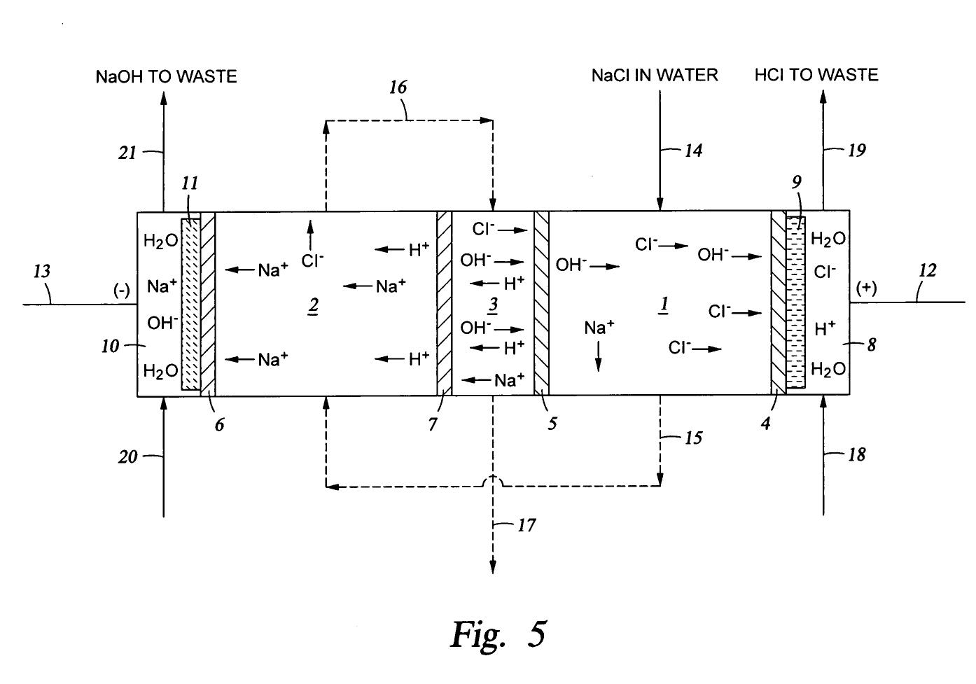

FIGS. 4 and 5 show the ion movement for the device in FIG. 3. In this example, water containing trace amounts of sodium chloride will be deionized using the device described in FIG. 3. For simplicity, the movement of the contaminant sodium ion and chloride ion will be described, but any cation or anion present in the water would be removed similarly to sodium and chloride, respectively.

The water stream, 14, to be purified enters the homogeneous anion depletion chamber 1. Sodium ions will pass directly through the homogeneous anion depletion chamber 1 as sodium hydroxide in the anion depleted water 15. The chloride will be retained on the anion exchange resin in the homogeneous anion depletion chamber 1. Under the force of the applied electric field, water splitting is occurring in the central heterogeneous anion and cation depletion chamber 3 producing hydronium and hydroxide.

Hydroxide from the central anion and cation depletion chamber 3 migrates through anion exchange membrane 5 into the homogeneous anion exchange resin in homogeneous anion depletion chamber 1. As the hydroxide present on the anion resin migrates towards the anode chamber 8 containing anode 9, chloride and other contaminants anions are also being electrophoretically driven towards the anode chamber 8. As chloride migrates from site to site in the anion exchange resin, hydroxide produced in the central heterogeneous anion and cation depletion chamber 3 will serve to keep the anion exchange resin in the hydroxide (regenerated form).

As chloride migrates through the anion exchange membrane 4 and into anode chamber 8, the chloride will combine with hydronium being produced at anode 9 resulting in the formation of hydrochloric acid which is continually swept from the anode chamber 8 by anode feed stream 18 and exiting the anode chamber as anode concentrate 19.

Sodium and other cations present in anion depleted water 15 enter the homogeneous cation depletion chamber 2 containing cation exchange resin. The sodium will be retained on the cation exchange resin in homogeneous cation depletion chamber 2. Under the force of the applied electric field, water is being split into hydronium and hydroxide in the central heterogeneous anion and cation depletion chamber 3.

Hydronium from the central heterogeneous anion and cation depletion chamber 3 migrates through cation exchange membrane 7 into the cation exchange resin in homogeneous cation depletion chamber 2. As the hydronium present in the cation resin migrates towards the cathode chamber 10 containing cathode 11, sodium and other contaminants cations are also being electrophoretically driven towards the cathode chamber 10. As the sodium migrates from site to site in the cation exchange resin, hydronium produced in the central heterogeneous anion and cation depletion chamber 3 will serve to keep the cation exchange resin in the hydronium (regenerated) form.

As the sodium eventually migrates through the cation exchange membrane 6 and into cathode chamber 10, the sodium will combine with hydroxide being produced at cathode 11 resulting in the formation of sodium hydroxide which is continually swept from the cathode chamber 10 by cathode feed stream 20 and exiting the cathode chamber as cathode concentrate 21.

The anion and cation depleted water 16 exits the homogeneous cation depletion chamber 2 and enters the central heterogeneous anion and cation depletion chamber 3 which is packed with a mixed bed of anion and cation exchange resin. Any anion not removed in the homogeneous anion depletion chamber 1 or any cation not removed in the homogeneous cation depletion chamber 2 may be removed in the central heterogeneous anion and cation depletion chamber 3. Chloride will be retained on anion exchange resin in the resin bed and under the force of the applied electric field will migrate towards and through anion exchange membrane 5, into the homogeneous anion depletion chamber 1 and eventually to the anion exchange membrane 4 and into the anode chamber 8. Sodium will be retained on cation exchange resin in the resin bed and under the force of the applied electric field will migrate towards and through cation exchange membrane 7, into homogeneous cation depletion chamber 2 and eventually to the cation exchange membrane 6 and into the cathode chamber 10. In addition, any ionic material leaching from the ion exchange materials in the homogeneous anion and cation depletion chambers 1 and 2 respectively, will be retained on the ion exchange material in central heterogeneous anion and cation depletion chamber 3. The product water 17 exits the device and is completely deionized.

Depending on the hardness of the water to be purified, it may be advantages to divert the anode concentrate 19 to the cathode feed stream 20 in order to minimize scaling (carbonate or hydroxide formation) in cathode chamber 10. Scaling results from the precipitation of low solubility salts such as CaCO₃ or bases, such as Mg(OH)₂. Cations removed from ion depletion chamber 2 and electrophoretically driven into cathode chamber 10 will be present in the hydroxide form. Less soluble hydroxides such as Mg(OH)₂ may begin to precipitate in the cathode chamber 10 and on the cathode 11 and the resulting precipitation may increase the electric resistance and lower the cation removal efficiency. Anode concentrate 19 will be acidic since the anions removed from the water stream 14 being purified will exit the anode compartment 8 in the acid (hydronium) form. By diverting the acidic anode concentrate 19 to the cathode feed stream 20, scaling can be reduced since the acidic anode concentrate will help to dissolve and keep in solution the less soluble hydroxides present in cathode chamber 10.

Data for Example Embodiments

### EXAMPLE 1

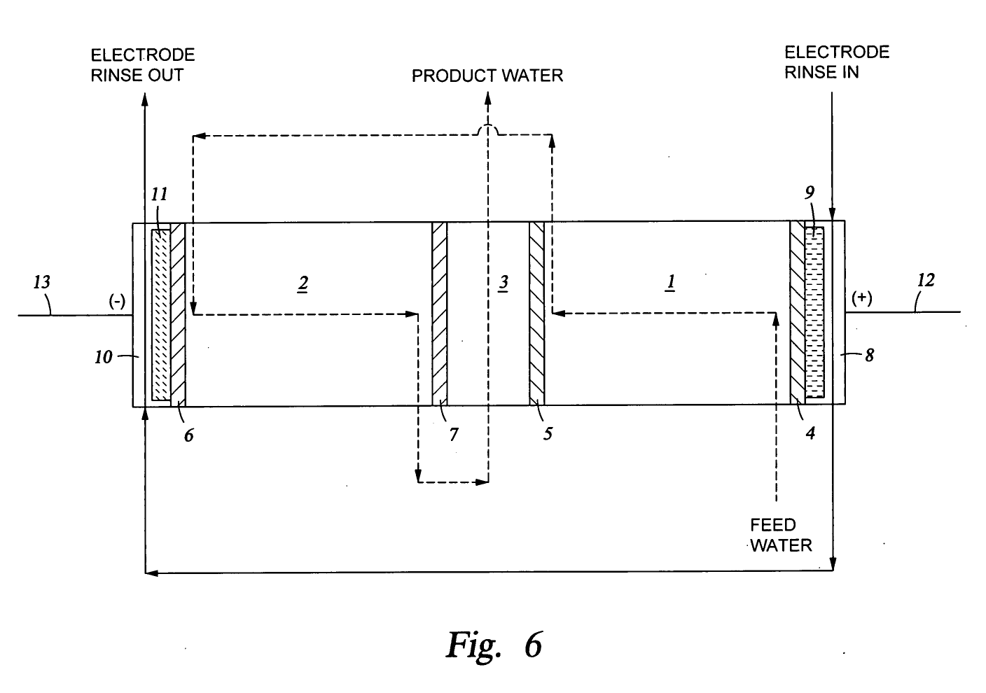

An EDI device as shown in FIG. 6 was constructed using machined high density polyethylene hardware to retain the electrodes, membranes and resin. The internal flow through dimensions of the homogeneous cation depletion chamber and homogeneous anion depletion chamber was 1.27 cm in diameter and 3.81 cm in length. The mixed bed compartment dimension was 1.27 cm (diameter) and 1.27 cm (length). Defining the homogeneous cation depletion chamber were cation exchange membranes (CMI-7000 Membranes International, Glen Rock, N.J.). Disposed between the cation exchange membranes was hydronium form Dowex 50Wx4 cation exchange resin (200 mesh). Defining the homogeneous anion depletion chamber were anion exchange membranes (AMI-7001 Membranes International, Glen Rock, N.J.). Disposed between the anion exchange membranes was hydroxide form Dowex 1x4 anion exchange resin (200 mesh). The mixed bed resin in the central heterogeneous anion and cation depletion chamber consisted of Dowex 50Wx4 and Dowex 1x4 in the hydronium and hydroxide forms, respectively. Platinum gauze electrodes (Unique Wire Weaving Inc, Hillside, N.J.) or similar were used.

A Barnant peristaltic pump was used to deliver reverse osmosis quality water (specific conductance 15.8 μS/cm) at a flow rate of 5.0 mL/min to the purification system. A Dionex CD20 conductivity detector with a flow through conductivity cell was used for the conductivity measurements. From the pump, the RO water flow was directed to the anion chamber, then to the cation chamber, next to the central (mixed bed) chamber and then to the flow through conductivity cell. From the conductivity cell, the flow was directed to the anode chamber and then the cathode chamber and finally to waste.

Initially, the conductance of the water exiting the EDI device was about 2 μs/cm. Using a VWR Accupower 4000 laboratory power supply, a constant current of 20 mA was applied and the initial voltage was 48V. Gas evolution was observed immediately from the anode and cathode chambers. The initial background conductivity of the product water was 13.2 μS/cm and over a one hour period the conductivity decreased to 1.1 μS/cm. The EDI device voltage had reduced to 29 V with a current of 20 mA. After approximately eight hours, the conductivity was 0.237 μS/cm and the voltage 24V. The EDI device was allowed to run uninterrupted for 24 hours and the product water conductivity was 0.103 μS/cm and the voltage was 24.7V with the 20 mA constant current. The EDI device was allowed to operate continuously for one week. Data was collected every 24 hours and the results shown below in Table 1.

TABLE 1
Conductance Measurements vs. Time (anion-cation-mixed bed)

| Hours | Voltage | Conductivity (μS/cm) |
|---|---|---|
| 1 | 43 | 13.2 |
| 2 | 25 | 0.103 |
| 8 | 22 | 0.092 |
| 32 | 23 | 0.075 |
| 56 | 26 | 0.071 |
| 80 | 29 | 0.073 |
| 104 | 30 | 0.071 |
| 128 | 32 | 0.070 |
| 152 | 31 | 0.068 |
| 176 | 32 | 0.069 |

### EXAMPLE 2

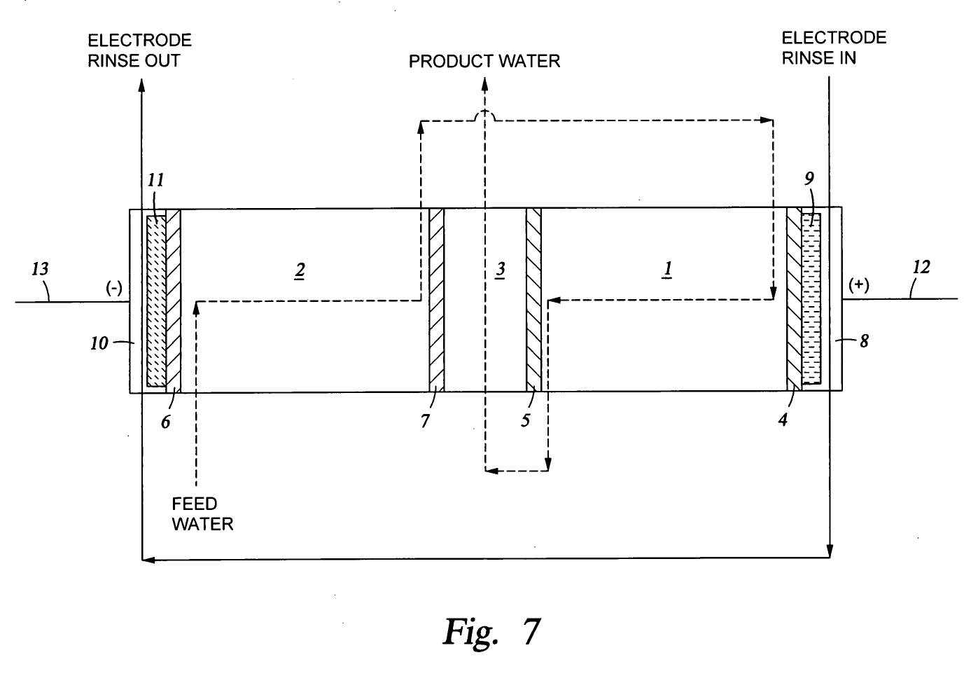

The same device in Example 1 was used, but the EDI device was configured so that the reverse osmosis water (specific conductance 13.3 μS/cm) from the pump was directed first to the homogeneous cation depletion chamber, the homogeneous anion depletion chamber and then the central heterogeneous anion and cation depletion chamber. The device was operated at 20 mA (constant current). See FIG. 7. The EDI device was allowed to run uninterrupted and data was collected every 24 hours and the results shown below in Table 2.

TABLE 2
Conductance Measurements vs. Time (cation-anion-mixed bed)

| Hours | Voltage | Conductivity (μS/cm) |
|---|---|---|
| 1 | 34 | 0.363 |
| 2 | 31 | 0.081 |
| 8 | 30 | 0.072 |
| 32 | 30 | 0.073 |
| 56 | 29 | 0.068 |
| 80 | 29 | 0.069 |
| 104 | 30 | 0.067 |
| 128 | 31 | 0.068 |
| 152 | 31 | 0.067 |
| 176 | 32 | 0.067 |

### EXAMPLE 3

The configuration shown in FIG. 3 used feed water that consisted of deionized water from a Barnstead EasyPure water purification that was spiked with common anions and cations as shown in Table 3. The spiked feed water was passed through the device of FIG. 6 at a flow rate of 2.0 mL/min first passing through the anion depletion chamber, then the cation depletion chamber and finally through the central (mixed bed) chamber. The device was operated at 20 mA constant current with a voltage of 28V. The product water was directed to the sample valve of a Dionex ICS 2000 ion chromatography that was configured for anion analysis. The volume of product water sampled from the central chamber EDI for the anion analysis was 10.0 mL.

The data in Table 3 shows the EDI device removed all the anions to a level less than 5 ng/L (parts-per-trillion). The Dionex ICS 2000 ion chromatography system was then converted for cation analysis. The volume of product water sampled from the central chamber EDI for the cation analysis was 10.0 mL. The data in Table 3 shows, the EDI device removed all the cations to a level less than 5 ng/L (parts-per-trillion).

TABLE 3
Ion Concentrations after EDI (anion-cation-mixed bed)

| | | Ion Concentration |
|---|---|---|
| | Spike | Recovered (μg/L) |
| | Concentration | (Anion to |
| Ion | (μg/L) | Cation to Mixed Bed) |
| Fluoride | 10,000 | <0.005 |
| Chloride | 10,000 | <0.005 |
| Nitrite | 10,000 | <0.005 |
| Bromide | 10,000 | <0.005 |
| Nitrate | 10,000 | <0.005 |
| Sulfate | 10,000 | <0.005 |
| Phosphate | 10,000 | <0.005 |
| Lithium | 10,000 | <0.005 |
| Ammonium | 10,000 | <0.005 |
| Sodium | 10,000 | <0.005 |
| Potassium | 10,000 | <0.005 |
| Calcium | 10,000 | <0.005 |
| Magnesium | 10,000 | <0.005 |

### EXAMPLE 4

The configuration shown in FIG. 3 used feed water that consisted of deionized water from a Barnstead EasyPure water purification that was spiked with common anions and cations as shown in Table 4. The spiked feed water was passed through the device of FIG. 7 at a flow rate of 2.0 mL/min first passing through the cation depletion chamber, then the anion depletion chamber and finally through the central (mixed bed) chamber. The device was operated at 20 mA constant current with a voltage of 28V. The product water was directed to the sample valve of a Dionex ICS 2000 ion chromatography that was configured for anion analysis. The volume of product water sampled from the central chamber EDI for the anion analysis was 10.0 mL.

The data in Table 4 shows the EDI device removed all the anions to a level less than 5 ng/L (parts-per-trillion). The Dionex ICS 2000 ion chromatography system was then converted for cation analysis. The volume of product water sampled from the central chamber EDI for the cation analysis was 10.0 mL. The data in Table 4 shows the EDI device removed all the cations to a level less than 5 ng/L (parts-per-trillion).

TABLE 4
Ion Concentrations after ED (cation-anion-mixed bed)

| | | Ion Concentration |
|---|---|---|
| | Spike | Recovered (μg/L) |
| | Concentration | (Cation to Anion |
| Ion | (μg/L) | to Mixed Bed) |
| Fluoride | 10,000 | <0.005 |
| Chloride | 10,000 | <0.005 |
| Nitrite | 10,000 | <0.005 |
| Bromide | 10,000 | <0.005 |
| Nitrate | 10,000 | <0.005 |
| Sulfate | 10,000 | <0.005 |
| Phosphate | 10,000 | <0.005 |
| Lithium | 10,000 | <0.005 |
| Ammonium | 10,000 | <0.005 |
| Sodium | 10,000 | <0.005 |
| Potassium | 10,000 | <0.005 |
| Calcium | 10,000 | <0.005 |
| Magnesium | 10,000 | <0.005 |

While the invention has been described in detail above with reference to several embodiments, various modifications within the scope and spirit of the invention will be apparent to those of working skill in this technological field. Accordingly, the scope of the invention should be measured by the appended claims.

1. A continuous electrodeionization (CEDI) apparatus with at least five discreet membrane bound chambers in electrical connection, wherein an electrical current runs through the CEDI apparatus transverse to the membranes, comprising:
(a) a first chamber comprising a cathode chamber;
(b) at least one second chamber comprising a homogeneous cation depletion chamber, where a homogeneous cation depletion chamber is located contiguous to the cathode chamber;
(c) a third chamber comprising a central heterogeneous anion and cation depletion chamber, where the heterogeneous anion and cation depletion chamber is located between and contiguous with a homogeneous cation depletion chamber and a homogeneous anion depletion chamber;
(d) at least one fourth chamber comprising a homogeneous anion depletion chamber, where a homogenous anion depletion chamber is located contiguous to an anode chamber; and
(e) a fifth chamber comprising an anode chamber.

2. A CEDI apparatus in accordance with claim 1, wherein each at least one second chamber is bounded by two cation exchange membranes and contains cation exchange material.

3. A CEDI apparatus in accordance with claim 2, wherein the cation exchange material is selected from the group consisting of cation exchange resins, cation exchange particles, cation exchange fibers, cation exchange screens, cation exchange monoliths, and combinations thereof.

4. A CEDI apparatus in accordance with claim 3, wherein the cation exchange material is cation exchange resins.

5. A CEDI apparatus in accordance with claim 1, wherein the at least one fourth chamber is bounded by two anion exchange membranes and contains anion exchange material.

6. A CEDI apparatus in accordance with claim 5, wherein the anion exchange material is selected from the group consisting of anion exchange resins, anion exchange particles, anion exchange fibers, anion exchange screens, anion exchange monoliths, and combinations thereof.

7. A CEDI apparatus in accordance with claim 6, wherein the anion exchange material is anion exchange resins.

8. A CEDI apparatus in accordance with claim 1, wherein the third chamber is bounded by a cation exchange membrane from the homogeneous cation depletion chamber and an anion exchange membrane from the homogeneous anion depletion chamber and the third chamber contains ion exchange material that is a heterogeneous mixture of anion and cation exchange material.

9. A CEDI apparatus in accordance with claim 8, wherein the ion exchange material in the third chamber is selected from the group consisting of ion exchange resins, ion exchange particles, ion exchange fibers, ion exchange screens, ion exchange monoliths, and combinations thereof.

10. A CEDI apparatus in accordance with claim 9, wherein the ion exchange material in the third chamber is a mixture of cation exchange resins and anion exchange resins.

11. A CEDI apparatus in accordance with claim 10, wherein hydrolysis of water occurs in the central heterogeneous anion and cation depletion chamber.

12. A CEDI apparatus in accordance with claim 11, wherein the hydrolysis of water in the third ion chamber results in the regeneration of the ion exchange material within the at least five chambers of the EDI apparatus.

13. A CEDI apparatus in accordance with claim 11, wherein the hydrolysis of water in the third chamber contributes to the generation of a uniform current through all five chambers without the use of layering or doping of ion exchange material.

14. A CEDI apparatus in accordance with claim 1, wherein the cathode chamber is bound on one side by a cation exchange membrane from the second chamber and contains a cathode that is in direct electrical contact with the cation exchange membrane of the second chamber.

15. A CEDI apparatus in accordance with claim 1, wherein the anode chamber is bound on one side by an anion exchange membrane from the fourth chamber, and contains an anode that is in direct electrical contact with an anion exchange membrane of the fourth chamber.

16. A CEDI apparatus in accordance with claim 1, wherein electrolysis of water occurs in the anode and cathode chambers.

17. A CEDI apparatus in accordance with claims 1-16, wherein five discreet membrane bound chambers are present in electrical connection.

18. A CEDI apparatus in accordance with claim 16, wherein hydronium ions from the electrolysis of water in the anode chamber combine with anions from the homogeneous anion depletion chamber to form an acidic solution in the anode chamber.

19. A CEDI apparatus in accordance with claim 18, wherein the acidic solution is diverted from the anode chamber to the cathode chamber to reduce scaling in the cathode chamber.

20. A CEDI apparatus in accordance with claim 1, wherein the ratio of the summation of the width of the at least one homogeneous cation depletion chamber: width of the central heterogeneous anion and cation depletion chamber: width of the summation of the at least one homogeneous anion depletion chamber ranges from 1:1:1 to 20:1:20.

21. A CEDI apparatus in accordance with claim 20, wherein the width ratio of the summation of the at least one homogeneous cation depletion chamber: width of the central heterogeneous anion and cation depletion chamber: width of the summation of the at least one homogeneous anion depletion chamber creates a symmetrical geometry with respect to the direction of current travel, which contributes to the generation of a uniform current through all homogeneous cation depletion chambers and all homogeneous anion depletion chambers without the use of layering or doping of ion exchange material.

22. A CEDI apparatus in accordance with claim 20, wherein the summation of the at least one homogeneous cation depletion chamber has a thickness ranging from about 12 mm to about 100 mm.

23. A CEDI apparatus in accordance with claim 22, wherein the summation of the at least one homogeneous cation depletion chamber has a thickness ranging from about 15 mm to about 40 mm.

24. A CEDI apparatus in accordance with claim 20, wherein the summation of the at least one homogeneous anion depletion chamber has a thickness ranging from about 12 mm to about 100 mm.

25. A CEDI apparatus in accordance with claim 24, wherein the summation of the at least one homogeneous anion depletion chamber has a thickness ranging from about 15 mm to about 40 mm.

26. A CEDI apparatus in accordance with claim 20, wherein the heterogeneous anion and cation depletion chamber has a thickness ranging from about 1 mm to about 100 mm.

27. A CEDI apparatus in accordance with claim 26, wherein the heterogeneous anion and cation depletion chamber has a thickness ranging from about 4.5 mm to about 12 mm.

28. A CEDI apparatus in accordance with claim 1, wherein the liquid flow within all ion depletion chambers is parallel to the membranes and perpendicular to the electric current.

29. A CEDI apparatus in accordance with claim 1, wherein the liquid flow within the at least one homogeneous anion depletion chamber and the at least one homogeneous cation depletion chamber is perpendicular to the membranes and parallel to the electric current.

30. A method of using a CEDI apparatus with at least five discreet membrane bound chambers in electrical connection, wherein an electrical current runs through the CEDI apparatus transverse to the membranes, comprising:
(a) flowing a liquid through at least one homogeneous cation depletion chamber, where a homogeneous cation depletion chamber is located contiguous to a cathode chamber, followed by;
(b) flowing a liquid through at least one homogeneous anion depletion chamber, where a homogeneous anion depletion chamber is located contiguous to a anode chamber, followed by;
(c) flowing a liquid through a central heterogeneous anion and cation depletion chamber, where the heterogeneous anion and cation depletion chamber is located between and contiguous with a homogeneous cation depletion chamber and a homogeneous anion depletion chamber; and
(d) flowing a liquid through a cathode chamber and an anode chamber.

31. A method of using a CEDI apparatus in accordance with claim 30, wherein electrolysis of water occurs in the anode and cathode chambers.

32. A method of using a CEDI apparatus in accordance with claim 31, wherein H⁺ ions from the electrolysis of water in the anode chamber combine with anions from the homogeneous anion depletion chamber to form an acidic solution in the anode chamber.

33. A method of using a CEDI apparatus in accordance with claim 32, wherein the acidic solution is diverted from the anode chamber to the cathode chamber to reduce scaling in the cathode chamber.

34. A method of using a CEDI apparatus in accordance with claim 30, wherein the ratio of the width of the summation of the at least one homogeneous cation depletion chamber: width of the central heterogeneous anion and cation depletion chamber: width of the summation of the at least one homogeneous anion depletion chamber ranges from 1:1:1 to 20:1:20.

35. A method of using a CEDI apparatus in accordance with claim 34, wherein the width ratio of the summation of the at least one homogeneous cation depletion chamber: width of the central heterogeneous anion and cation depletion chamber: width of the summation of the at least one homogeneous anion depletion chamber creates a symmetrical geometry with respect to the direction of current travel, which contributes to the generation of a uniform current through all homogeneous cation depletion chambers and all homogeneous anion depletion chambers without the use of layering or doping of ion exchange material.

36. A method of using a CEDI apparatus in accordance with claim 30, wherein the summation of the at least one homogeneous cation depletion chamber has a thickness ranging from about 12 mm to about 100 mm.

37. A method of using a CEDI apparatus in accordance with claim 36, wherein the summation of the at least one homogeneous cation depletion chamber has a thickness ranging from about 15 mm to about 40 mm.

38. A method of using a CEDI apparatus in accordance with claim 30, wherein the summation of the at least one homogeneous anion depletion chamber has a thickness ranging from about 12 mm to about 100 mm.

39. A method of using a CEDI apparatus in accordance with claim 38, wherein the summation of the at least one homogeneous anion depletion chamber has a thickness ranging from about 15 mm to about 40 mm.

40. A method of using a CEDI apparatus in accordance with claim 30, wherein the heterogeneous anion and cation depletion chamber has a thickness ranging from about 1 mm to about 100 mm.

41. A method of using a CEDI apparatus in accordance with claim 40, wherein the heterogeneous anion and cation depletion chamber has a thickness ranging from about 4.5 mm to about 12 mm.

42. A method of using a CEDI apparatus in accordance with claim 30, wherein the liquid flow within all ion depletion chambers is parallel to the membranes and perpendicular to the electric current.

43. A method of using a CEDI apparatus in accordance with claim 30, wherein the liquid flow within the at least one homogeneous anion depletion chamber and the at least one homogeneous cation depletion chamber is perpendicular to the membranes and parallel to the electric current.

44. A method of using a CEDI apparatus with at least five discreet membrane bound chambers in electrical connection, wherein an electrical current runs through the CEDI apparatus transverse to the membranes, comprising:
(a) flowing a liquid through at least one homogeneous anion depletion chamber, where a homogeneous anion depletion chamber is located contiguous to a anode chamber, followed by;
(b) flowing a liquid through at least one homogeneous cation depletion chamber, where a homogeneous cation depletion chamber is located contiguous to a cathode chamber, followed by;
(c) flowing a liquid through a central heterogeneous anion and cation depletion chamber, where the heterogeneous anion and cation depletion chamber is located between and contiguous with a homogeneous cation depletion chamber and a homogeneous anion depletion chamber; and
(d) flowing a liquid through a cathode chamber and an anode chamber.

45. A method of using a CEDI apparatus in accordance with claim 44, wherein electrolysis of water occurs in the anode and cathode chambers.

46. A method of using a CEDI apparatus in accordance with claim 45, wherein H⁺ ions from the electrolysis of water in the anode chamber combine with anions from the homogeneous anion depletion chamber to form an acidic solution in the anode chamber.

47. A method of using a CEDI apparatus in accordance with claim 46, wherein the acidic solution is diverted from the anode chamber to the cathode chamber to reduce scaling in the cathode chamber.

48. A method of using a CEDI apparatus in accordance with claim 44, wherein the ratio of the width of the summation of the at least one homogeneous cation depletion chamber: width of the central heterogeneous anion and cation depletion chamber: width of the summation of the at least one homogeneous anion depletion chamber ranges from 1:1:1 to 20:1:20.

49. A method of using a CEDI apparatus in accordance with claim 48, wherein the width ratio of the summation of the at least one homogeneous cation depletion chamber: width of the central heterogeneous anion and cation depletion chamber: width of the summation of the at least one homogeneous anion depletion chamber creates a symmetrical geometry with respect to the direction of current travel, which contributes to the generation of a uniform current through all homogeneous cation depletion chambers and all homogeneous anion depletion chambers without the use of layering or doping of ion exchange material.

50. A method of using a CEDI apparatus in accordance with claim 44, wherein the summation of the at least one homogeneous cation depletion chamber has a thickness ranging from about 12 mm to about 100 mm.

51. A method of using a CEDI apparatus in accordance with claim 50, wherein the summation of the at least one homogeneous cation depletion chamber has a thickness ranging from about 15 mm to about 40 mm.

52. A method of using a CEDI apparatus in accordance with claim 44, wherein the summation of the at least one homogeneous anion depletion chamber has a thickness ranging from about 12 mm to about 100 mm.

53. A method of using a CEDI apparatus in accordance with claim 52, wherein the summation of the at least one homogeneous anion depletion chamber has a thickness ranging from about 15 mm to about 40 mm.

54. A method of using a CEDI apparatus in accordance with claim 44, wherein the heterogeneous anion and cation depletion chamber has a thickness ranging from about 1 mm to about 100 mm.

55. A method of using a CEDI apparatus in accordance with claim 54, wherein the heterogeneous anion and cation depletion chamber has a thickness ranging from about 4.5 mm to about 12 mm.

56. A method of using a CEDI apparatus in accordance with claim 44, wherein the liquid flow within all ion depletion chambers is parallel to the membranes and perpendicular to the electric current.

57. A method of using a CEDI apparatus in accordance with claim 44, wherein the liquid flow within the at least one homogeneous anion depletion chamber and the at least one homogeneous cation depletion chamber is perpendicular to the membranes and parallel to the electric current.

58. A method of using a CEDI apparatus with five discreet membrane bound chambers in electrical connection, wherein an electrical current runs through the CEDI apparatus transverse to the membranes, comprising:
(a) flowing a liquid through a homogeneous cation depletion chamber, where the homogeneous cation depletion chamber has a thickness ranging from about 12 mm to about 100 mm and is located contiguous to a cathode chamber, followed by;
(b) flowing a liquid through a homogeneous anion depletion chamber, where the homogeneous anion depletion chamber has a thickness ranging from about 12 mm to about 100 mm and is located contiguous to a anode chamber, followed by;
(c) flowing a liquid through a central heterogeneous anion and cation depletion chamber, where the heterogeneous anion and cation depletion chamber has a thickness ranging from about 1 mm to about 100 mm and is located between and contiguous with a homogeneous cation depletion chamber and a homogeneous anion depletion chamber; and
(d) flowing a liquid through a cathode chamber and an anode chamber.

59. A method of using a CEDI apparatus in accordance with claim 58, wherein the homogeneous cation depletion chamber has a thickness ranging from 15 mm to 40 mm, the homogeneous anion depletion chamber has a thickness ranging from about 15 mm to about 40 mm, and the heterogeneous anion and cation depletion chamber has a thickness ranging from about 4.5 mm to about 12 mm.

60. A method of using a CEDI apparatus with five discreet membrane bound chambers in electrical connection, wherein an electrical current runs through the CEDI apparatus transverse to the membranes, comprising:
(a) flowing a liquid through a homogeneous anion depletion chamber, where the homogeneous anion depletion chamber has a thickness ranging from about 12 mm to about 100 mm and is located contiguous to an anode chamber, followed by;
(b) flowing a liquid through a homogeneous cation depletion chamber, where the homogeneous cation depletion chamber has a thickness ranging from about 12 mm to about 100 mm and is located contiguous to a cathode chamber, followed by;
(c) flowing a liquid through a central heterogeneous anion and cation depletion chamber, where the heterogeneous anion and cation depletion chamber has a thickness ranging from about 1 mm to about 100 mm and is located between and contiguous with a homogeneous cation depletion chamber and a homogeneous anion depletion chamber; and
(d) flowing a liquid through a cathode chamber and an anode chamber.

61. A method of using a CEDI apparatus in accordance with claim 58, wherein the homogeneous cation depletion chamber has a thickness ranging from 15 mm to 40 mm, the homogeneous anion depletion chamber has a thickness ranging from about 15 mm to about 40 mm, and the heterogeneous anion and cation depletion chamber has a thickness ranging from about 4.5 mm to about 12 mm.

62. A CEDI apparatus in accordance with claim 1, wherein the ratio of the width of the at least one homogeneous cation depletion chamber to the width of the central heterogeneous anion and cation depletion chamber ranges from 1.25:1 to 100:1;
and the ratio of the width of the at least one homogeneous anion depletion chamber to the width of the central heterogeneous anion and cation depletion chamber ranges from 1.25:1 to 100:1.

63. A CEDI apparatus in accordance with claim 62, wherein the ratio of the width of the at least one homogeneous cation depletion chamber to the width of the central heterogeneous anion and cation depletion chamber ranges from 2.7:1 to 8.8:1; and
the ratio of the width of the at least one homogeneous anion depletion chamber to the width of the central heterogeneous anion and cation depletion chamber ranges from 2.7:1 to 8.8:1.

64. A CEDI apparatus in accordance with claim 62, wherein the ratio of the width of the at least one homogeneous cation depletion chamber to the width of the central heterogeneous anion and cation depletion chamber ranges from 8.3:1 to 100:1; and
the ratio of the width of the at least one homogeneous anion depletion chamber to the width of the central heterogeneous anion and cation depletion chamber ranges from 8.3:1 to 100:1.

65. A CEDI apparatus in accordance with claim 62 or claim 64, wherein the ratio of the width of the at least one homogeneous cation depletion chamber to the width of the central heterogeneous anion and cation depletion chamber ranges from 8.3:1 to 20:1; and the ratio of the width of the at least one homogeneous anion depletion chamber to the width of the central heterogeneous anion and cation depletion chamber ranges from 8.3:1 to 20:1.

66. A method of using a CEDI apparatus in accordance with claim 30, wherein the ratio of the width of the at least one homogeneous cation depletion chamber to the width of the central heterogeneous anion and cation depletion chamber ranges from 1.25:1 to 100:1; and the ratio of the width of the at least one homogeneous anion depletion chamber to the width of the central heterogeneous anion and cation depletion chamber ranges from 1.25:1 to 100:1.

67. A method of using a CEDI apparatus in accordance with claim 66, wherein the ratio of the width of the at least one homogeneous cation depletion chamber to the width of the central heterogeneous anion and cation depletion chamber ranges from 2.7:1 to 8.8:1; and the ratio of the width of the at least one homogeneous anion depletion chamber to the width of the central heterogeneous anion and cation depletion chamber ranges from 2.7:1 to 8.8:1.

68. A method of using a CEDI apparatus in accordance with claim 66, wherein the ratio of the width of the at least one homogeneous cation depletion chamber to the width of the central heterogeneous anion and cation depletion chamber ranges from 8.3:1 to 100:1; and the ratio of the width of the at least one homogeneous anion depletion chamber to the width of the central heterogeneous anion and cation depletion chamber ranges from 8.3:1 to 100:1.

69. A method of using a CEDI apparatus in accordance with claim 66 or claim 68, wherein the ratio of the width of the at least one homogeneous cation depletion chamber to the width of the central heterogeneous anion and cation depletion chamber ranges from 8.3:1 to 20:1; and the ratio of the width of the at least one homogeneous anion depletion chamber to the width of the central heterogeneous anion and cation depletion chamber ranges from 8.3:1 to 20:1.

70. A method of using a CEDI apparatus in accordance with claim 44, wherein the ratio of the width of the at least one homogeneous cation depletion chamber to the width of the central heterogeneous anion and cation depletion chamber ranges from 1.25:1 to 100:1; and the ratio of the width of the at least one homogeneous anion depletion chamber to the width of the central heterogeneous anion and cation depletion chamber ranges from 1.25:1 to 100:1.

71. A method of using a CEDI apparatus in accordance with claim 70, wherein the ratio of the width of the at least one homogeneous cation depletion chamber to the width of the central heterogeneous anion and cation depletion chamber ranges from 2.7:1 to 8.8:1; and the ratio of the width of the at least one homogeneous anion depletion chamber to the width of the central heterogeneous anion and cation depletion chamber ranges from 2.7:1 to 8.8:1.

72. A method of using a CEDI apparatus in accordance with claim 70, wherein the ratio of the width of the at least one homogeneous cation depletion chamber to the width of the central heterogeneous anion and cation depletion chamber ranges from 8.3:1 to 100:1; and the ratio of the width of the at least one homogeneous anion depletion chamber to the width of the central heterogeneous anion and cation depletion chamber ranges from 8.3:1 to 100:1.

73. A method of using a CEDI apparatus in accordance with claim 70 or claim 72, wherein the ratio of the width of the at least one homogeneous cation depletion chamber to the width of the central heterogeneous anion and cation depletion chamber ranges from 8.3:1 to 20:1; and the ratio of the width of the at least one homogeneous anion depletion chamber to the width of the central heterogeneous anion and cation depletion chamber ranges from 8.3:1 to 20:1.

74. A method of using a CEDI apparatus in accordance with claim 58, wherein the ratio of the width of the at least one homogeneous cation depletion chamber to the width of the central heterogeneous anion and cation depletion chamber ranges from 1.25:1 to 100:1; and the ratio of the width of the at least one homogeneous anion depletion chamber to the width of the central heterogeneous anion and cation depletion chamber ranges from 1.25:1 to 100:1.

75. A method of using a CEDI apparatus in accordance with claim 74, wherein the ratio of the width of the at least one homogeneous cation depletion chamber to the width of the central heterogeneous anion and cation depletion chamber ranges from 2.7:1 to 8.8:1; and the ratio of the width of the at least one homogeneous anion depletion chamber to the width of the central heterogeneous anion and cation depletion chamber ranges from 2.7:1 to 8.8:1.

76. A method of using a CEDI apparatus in accordance with claim 74, wherein the ratio of the width of the at least one homogeneous cation depletion chamber to the width of the central heterogeneous anion and cation depletion chamber ranges from 8.3:1 to 100:1; and the ratio of the width of the at least one homogeneous anion depletion chamber to the width of the central heterogeneous anion and cation depletion chamber ranges from 8.3:1 to 100:1.

77. A method of using a CEDI apparatus in accordance with claim 74 or claim 76, wherein the ratio of the width of the at least one homogeneous cation depletion chamber to the width of the central heterogeneous anion and cation depletion chamber ranges from 8.3:1 to 20:1; and the ratio of the width of the at least one homogeneous anion depletion chamber to the width of the central heterogeneous anion and cation depletion chamber ranges from 8.3:1 to 20:1.

78. A method of using a CEDI apparatus in accordance with claim 60, wherein the ratio of the width of the at least one homogeneous cation depletion chamber to the width of the central heterogeneous anion and cation depletion chamber ranges from 1.25:1 to 100:1; and the ratio of the width of the at least one homogeneous anion depletion chamber to the width of the central heterogeneous anion and cation depletion chamber ranges from 1.25:1 to 100:1.

79. A method of using a CEDI apparatus in accordance with claim 78, wherein the ratio of the width of the at least one homogeneous cation depletion chamber to the width of the central heterogeneous anion and cation depletion chamber ranges from 2.7:1 to 8.8:1; and the ratio of the width of the at least one homogeneous anion depletion chamber to the width of the central heterogeneous anion and cation depletion chamber ranges from 2.7:1 to 8.8:1.

80. A method of using a CEDI apparatus in accordance with claim 78, wherein the ratio of the width of the at least one homogeneous cation depletion chamber to the width of the central heterogeneous anion and cation depletion chamber ranges from 8.3:1 to 100:1; and the ratio of the width of the at least one homogeneous anion depletion chamber to the width of the central heterogeneous anion and cation depletion chamber ranges from 8.3:1 to 100:1.

81. A method of using a CEDI apparatus in accordance with claim 78 or claim 80, wherein the ratio of the width of the at least one homogeneous cation depletion chamber to the width of the central heterogeneous anion and cation depletion chamber ranges from 8.3:1 to 20:1; and the ratio of the width of the at least one homogeneous anion depletion chamber to the width of the central heterogeneous anion and cation depletion chamber ranges from 8.3:1 to 20:1.
